(19) United States
(12) Patent Application Publication
(10) Pub. No.: US 2016/0161609 A1
(43) Pub. Date: Jun. 9, 2016

(54) OBJECT DETECTION DEVICE, VELOCITY DETECTION DEVICE, AND VEHICLE

(71) Applicant: Panasonic Intellectual Property Management Co., Ltd., Osaka (JP)

(72) Inventors: HIROSHI TANAKA, Osaka (JP); YASUMICHI TAKAI, Hyogo (JP)

(21) Appl. No.: 14/886,971

(22) Filed: Oct. 19, 2015

(30) Foreign Application Priority Data
Dec. 5, 2014 (JP) 2014-247286

(51) Int. Cl. G01S 13/93; G01S 13/60

(52) U.S. Cl. CPC G01S 13/931; G01S 13/60; G01S 2013/9353; G01S 2013/9389

(57) ABSTRACT

An object detection device to be mounted on a mobile body includes: a transmit antenna; a receive antenna; first circuitry that causes the transmit antenna to alternately switch between first and the second beams and transmits radio signals, and that receives, by using the receive antenna, reflected wave signals; and second circuitry that detects a ground velocity of the mobile body corresponding to an azimuth, on the basis of a radio signal transmitted by using the first beam and a reflected wave signal obtained as a result of radio waves of the radio signal being reflected on a road surface, and that detects a relative velocity of the object regarding the mobile body, on the basis of a radio signal transmitted by using the second beam and a reflected wave signal obtained as a result of radio waves of the radio signal being reflected on an object.

### BACKGROUND

1. Technical Field

The present disclosure relates to an object detection device to be mounted on a mobile body, such as a car, so as to detect an object around the mobile body, a velocity detection device to be mounted on a mobile body so as to detect a ground velocity of the mobile body, and a vehicle, such as a car.

2. Description of the Related Art

An object detection device including a radar system to be mounted on a mobile body, such as a car, so as to detect an object, such as an obstacle, around the mobile body is available. Japanese Unexamined Patent Application Publication No. 2008-168759 discloses an obstacle recognition device for a vehicle. This obstacle recognition device includes a radar system that detects the presence of an obstacle ahead of a vehicle, a yaw rate sensor that detects the yaw rate of the vehicle, a vehicle velocity sensor that detects the velocity of the vehicle, a traveling area estimating unit that estimates a traveling area of the vehicle, on the basis of a value of the yaw rate detected by the yaw rate sensor and the velocity of the vehicle detected by the vehicle velocity sensor, and a determining unit that determines whether or not an obstacle detected by the radar system is present in the traveling area estimated by the traveling area estimating unit.

This obstacle recognition device also includes a correcting unit that corrects the value of the yaw rate detected by the yaw rate sensor in accordance with the velocity of the vehicle detected by the vehicle velocity sensor. The traveling area estimating unit estimates a traveling area of the vehicle, on the basis of the value of the yaw rate corrected by the correcting unit and the velocity of the vehicle detected by the vehicle velocity sensor.

### SUMMARY

One non-limiting and exemplary embodiment provides an object detection device which is able to enhance the precision in detecting the movement of an object around a mobile body by detecting the movement of the mobile body by using the same device as that detecting the movement of the object.

In one general aspect, the techniques disclosed here feature an object detection device to be mounted on a mobile body (e.g. a vehicle) which moves on a road surface so as to detect an object around the mobile body. The object detection device includes: a transmit antenna that selectively switches between a first beam having a first angle of depression and being directed to the road surface and a second beam having a second angle of depression and being directed to the object, the second angle of depression being smaller than the first angle of depression; a receive antenna; first circuitry that causes the transmit antenna to alternately switch between the first and the second beams and transmits radio signals by using the first beam and the second beam, and that receives, by using the receive antenna, reflected wave signals returned in response to the transmitted radio signals; and second circuitry that detects at least one ground velocity of the mobile body corresponding to at least one azimuth, on the basis of a radio signal transmitted by using the first beam and a reflected wave signal obtained as a result of radio waves of the radio signal transmitted by using the first beam being reflected on the road surface, and that detects a relative velocity of the object regarding the mobile body, on the basis of a radio signal transmitted by using the second beam and a reflected wave signal obtained as a result of radio waves of the radio signal transmitted by using the second beam being reflected on the object.

It should be noted that general or specific embodiments may be implemented as an object detection device, a velocity detection device, a vehicle, a system, a method, an integrated circuit, a computer program, a storage medium, or any selective combination thereof.

By using an object detection device according to one aspect of the present disclosure, it is possible to enhance the precision in detecting the movement of an object around a mobile body by detecting the movement of the mobile body by using the same device as that detecting the movement of the object.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating an example of the configuration of an object detection device according to a first embodiment of the present disclosure;

FIG. 2 is a side view illustrating, together with an obstacle, a car on which the object detection device shown in FIG. 1 is mounted;

FIG. 3 is a side view illustrating an operation for detecting the ground velocity of the car by the object detection device shown in FIG. 2;

FIG. 4 is a flowchart illustrating object detection processing performed by the object detection device shown in FIG. 1;

FIG. 5 is a block diagram illustrating an example of the configuration of an object detection device according to a second embodiment of the present disclosure;

FIG. 6A is a plan view illustrating a car on which the object detection device shown in FIG. 5 is mounted;

FIG. 6B is a side view illustrating the car shown in FIG. 6A;

FIG. 7 is a flowchart illustrating object detection processing performed by the object detection device shown in FIG. 5;

FIG. 8 is a graph illustrating the results of detecting the velocities of objects by the object detection processing shown in FIG. 7;

FIG. 9 is a block diagram illustrating an example of the configuration of an object detection device according to a third embodiment of the present disclosure;

FIG. 10A is a plan view illustrating a car on which the object detection device shown in FIG. 9 is mounted;

FIG. 10B is a side view illustrating the car shown in FIG. 10A;

FIG. 11 is a flowchart illustrating object detection processing performed by the object detection device shown in FIG. 9;

FIG. 12 is a graph illustrating the results of detecting the velocities of objects by the object detection processing shown in FIG. 11;

FIG. 13 is a perspective view illustrating an example of the configuration of a radar transmitter and receiver of an object detection device according to a fourth embodiment of the present disclosure;

FIG. 14 is a timing chart illustrating the timing of ground transmission and horizontal transmission in object detection processing performed by the object detection device including the radar transmitter and receiver shown in FIG. 13; and

FIG. 15 is a flowchart illustrating object detection processing performed by the object detection device including the radar transmitter and receiver shown in FIG. 13.

### DETAILED DESCRIPTION

### (Underlying Knowledge Forming Basis of the Present Disclosure)

In the obstacle recognition device disclosed in Japanese Unexamined Patent Application Publication No. 2008-168759, the relative velocity of an obstacle regarding the velocity of the vehicle is detected by the radar system. A determination as to whether the obstacle is present in the traveling area of the vehicle is made on the basis of the velocity of the vehicle detected by the vehicle velocity sensor. With this configuration, in the case of the occurrence of, for example, tire slip of the vehicle, the velocity of the vehicle is not correctly detected, thereby decreasing the precision in making a determination as to whether an object detected by the radar system is a moving object or a still object.

In view of this problem, the present inventors have conducted intensive and extensive study to provide an object detection device and a vehicle that are capable of detecting the movement of an object around a mobile body or the vehicle with higher precision than the related art. The present inventors have also conducted intensive and extensive study to provide a velocity detection device and a vehicle that are capable of detecting multiple ground velocities of a mobile body or the vehicle corresponding to multiple azimuths with higher precision than the related art.

Embodiments of the present disclosure will be described below with reference to the accompanying drawings. In the following embodiments, the same or similar elements are designated by the same reference numeral.

### First Embodiment

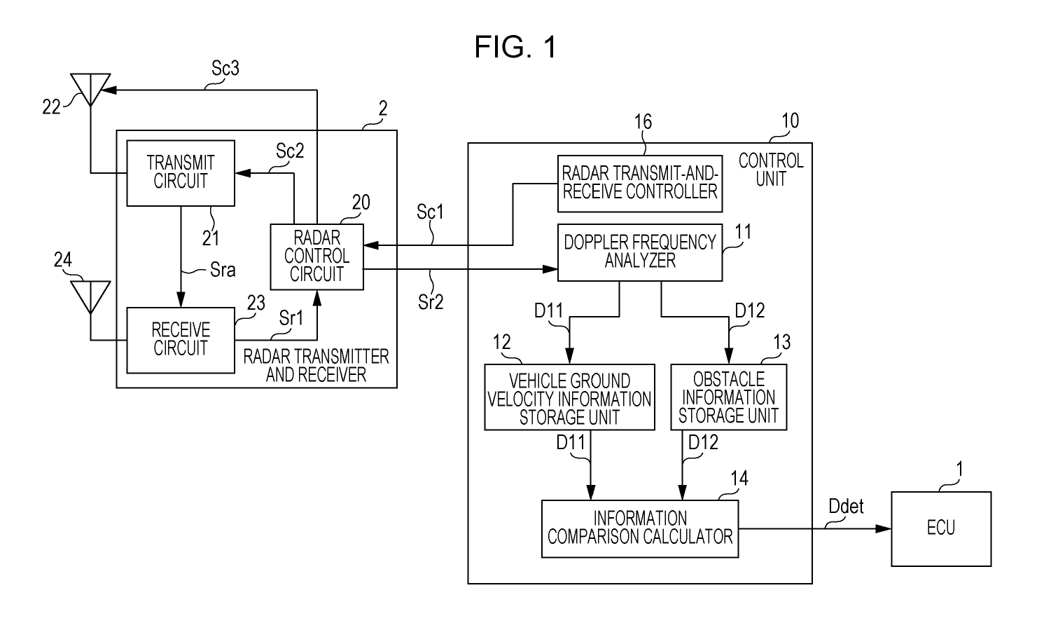

FIG. 1 is a block diagram illustrating an example of the configuration of an object detection device according to a first embodiment of the present disclosure. In FIG. 1, the object detection device according to the first embodiment includes a radar transmitter and receiver 2, a control unit 10, and an electronic control unit (hereinafter referred to as the “ECU”) 1. The radar transmitter and receiver 2 is constituted by a millimeter-wave radar system, and includes a radar control circuit 20, a transmit circuit 21, a transmit antenna 22, a receive circuit 23, and a receive antenna 24. The control unit 10 is constituted by, for example, a central processing unit (CPU), a read only memory (ROM), and a random access memory (RAM), and includes a Doppler frequency analyzer 11, a vehicle ground velocity information storage unit 12, an obstacle information storage unit 13, an information comparison calculator 14, and a radar transmit-and-receive controller 16. The ECU 1 is constituted by, for example, a driver assistance system unit, such as an advanced driver assistance system (ADAS), or a vehicle front monitoring unit.

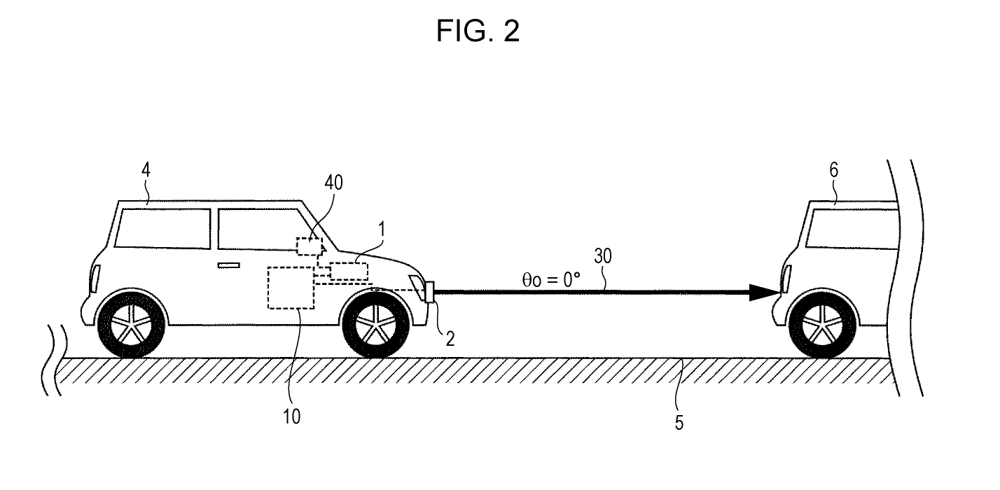

In FIG. 1, the radar transmit-and-receive controller 16 of the control unit 10 generates a radar control signal Sc1 for detecting an obstacle 6 (see FIG. 2), which will be discussed in detail later, and outputs the generated radar control signal Sc1 to the radar control circuit 20 of the radar transmitter and receiver 2. The radar control signal Sc1 is a control signal for controlling a transmit-and-receive operation performed by the radar transmitter and receiver 2. Radar waves are electromagnetic waves having a frequency of a millimeter-wave band, such as a frequency band of 76 to 81 GHz. Radar waves are an example of radio signals. The radar transmitter and receiver 2 is an example of first circuitry that radiates radar waves by switching the beam direction of the transmit antenna 22 and receives reflected wave signals indicating reflected waves returned in response to the radar waves.

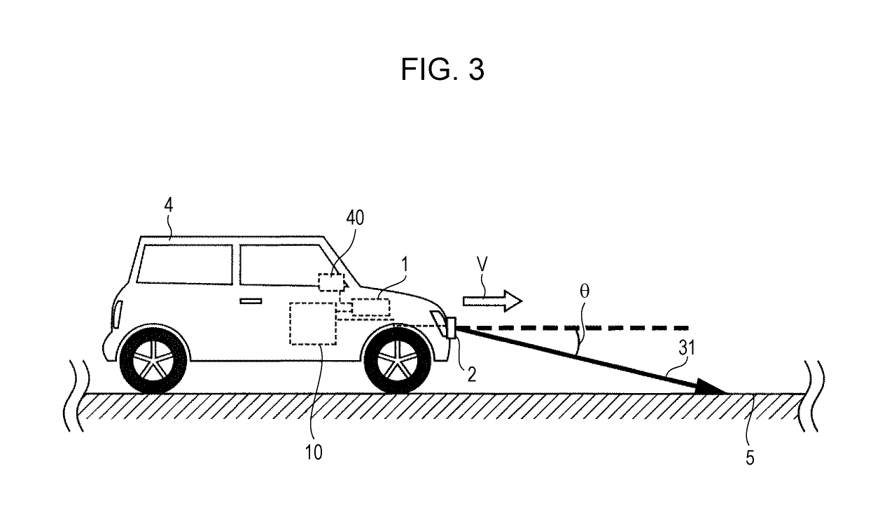

On the basis of the radar control signal Sc1, the radar control circuit 20 generates a transmit control signal Sc2 for controlling a transmit operation for a radio signal and outputs the transmit control signal Sc2 to the transmit circuit 21. The radar control circuit 20 also generates a transmit antenna control signal Sc3 for controlling the switching of the beam direction of the transmit antenna 22 and outputs the transmit antenna control signal Sc3 to the transmit antenna 22. On the basis of the transmit control signal Sc2, the transmit circuit 21 generates a radio-transmit signal corresponding to the period indicated by the transmit control signal Sc2 and outputs the radio-transmit signal to the transmit antenna 22. The transmit circuit 21 also splits the generated radio-transmit signal into a transmit signal Sra and outputs the transmit signal Sra to the receive circuit 23. The transmit antenna 22 is an antenna that can mechanically or electrically switch the beam direction. If the transmit antenna 22 mechanically switches the beam direction, it is an antenna that can change the antenna plane by using a motor on the basis of the transmit antenna control signal Sc3. If the transmit antenna 22 electrically switches the beam direction, a variable directivity antenna constituted by, for example, a phased array antenna, is used. If a variable directivity antenna is used, the transmit antenna control signal Sc3 may be omitted, and the transmit antenna 22 may radiate radar waves by switching the beam direction under the control of the transmit control signal Sc2. In the first embodiment, the transmit antenna 22 selectively switches the beam direction to a horizontal beam 30 or a ground beam 31 (see FIGS. 2 and 3), which will be discussed in detail later.

The receive antenna 24 is constituted by a directional antenna having a predetermined directivity, and receives reflected wave signals indicating reflected waves returned in response to radar waves transmitted from the transmit antenna 22. In response to a reflected wave signal received by the receive antenna 24, the receive circuit 23 multiplies the reflected wave signal by part of the transmit signal Sra so as to generate a signal Sr1 indicating a multiplication result, and outputs the signal Sr1 to the radar control circuit 20. The radar control circuit 20 then performs predetermined signal processing, such as low-pass filtering, on the signal Sr1 so as to generate a baseband signal Sr2, and transmits the baseband signal Sr2 to the Doppler frequency analyzer 11 of the control unit 10. The radar method used in the radar transmitter and receiver 2 may be the FM modulation method or the digital method in which radar waves to be transmitted are represented in the form of pulses.

In the control unit 10, the Doppler frequency analyzer 11 analyzes the Doppler frequency on the basis of the baseband signal Sr2 by performing Fourier transform processing (for example, fast Fourier transform (FFT)), which will be discussed in detail later. Instead of FFT, discrete Fourier transform (DFT) or arithmetic Fourier transform (AFT) may be used. If the radar transmitter and receiver 2 has transmitted a radio signal by using a ground beam 31 (see FIG. 3), the Doppler frequency analyzer 11 detects a vehicle ground velocity on the basis of the analyzed Doppler frequency and then stores vehicle ground velocity information D11 indicating the detected vehicle ground velocity in the vehicle ground velocity information storage unit 12. If the radar transmitter and receiver 2 has transmitted a radio signal by using a horizontal beam 30, the Doppler frequency analyzer 11 detects a relative velocity of an obstacle on the basis of the analyzed Doppler frequency and stores obstacle information D12 in the obstacle information storage unit 13, obstacle information D12 including information concerning the detected relative velocity. The Doppler frequency analyzer 11 is an example of velocity detection circuitry that detects the ground velocity of a car 4 and the relative velocity of an obstacle on the basis of the Doppler frequency of the baseband signal Sr2.

The vehicle ground velocity information storage unit 12 and the obstacle information storage unit 13 are constituted by, for example, RAMs. The information comparison calculator 14 reads the vehicle ground velocity information D11 from the vehicle ground velocity information storage unit 12 and also reads the obstacle information D12 from the obstacle information storage unit 13. The information comparison calculator 14 then determines whether the obstacle is moving or still, which will be discussed in detail later, on the basis of the ground velocity indicated by the vehicle ground velocity information D11 and the relative velocity of the obstacle indicated by the obstacle information D12. The information comparison calculator 14 generates object detection data Ddet indicating determination results and outputs the object detection data Ddet to the ECU 1. The ECU 1 controls warning and/or braking on the basis of the object detection data Ddet received from the control unit 10.

FIG. 2 is a side view illustrating, together with an obstacle 6, the car 4 on which the object detection device shown in FIG. 1 is mounted. FIG. 3 is a side view illustrating an operation for detecting the ground velocity of the car 4 by the object detection device shown in FIG. 2. In FIG. 2, the object detection device of the first embodiment is mounted on the car 4. The radar transmitter and receiver 2 is fixed on the front side of the car 4 in the first embodiment. The control unit 10 is installed within the car 4 and is connected to the ECU 1 of the car 4. Although the control unit 10 is disposed separately from the radar transmitter and receiver 2 in FIGS. 2 and 3, it may be integrated into the radar transmitter and receiver 2 as a single module and may be mounted at the position at which the radar transmitter and receiver 2 is located in FIGS. 2 and 3. The ECU 1 may be constituted by, for example, a power-train control module for controlling the engines of the car 4 or a brake control module for controlling the brakes of the car 4. The ECU 1 may be connected to a display unit 40 constituted by, for example, a liquid crystal display or a head-up display. The display unit 40 is fixed at the driver's seat within the car 4.

In FIG. 2, the car 4 is running on a road surface 5, and the obstacle 6, such as a vehicle, is present ahead of the car 4. In the object detection device of the first embodiment, the radar transmitter and receiver 2 forms a horizontal beam 30 in a direction parallel with the road surface 5, radiates radar waves toward the obstacle 6, and detects the obstacle 6 on the basis of a reflected wave signal returned from the obstacle 6. An object to be detected by the radar transmitter and receiver 2 as described above may be a running vehicle, a still vehicle, or a pedestrian. The object detection device detects the relative velocity of the obstacle 6 and the ground velocity of the car 4 so as to determine whether the obstacle 6 is a moving object or a still object.

In FIG. 3, the radar transmitter and receiver 2 forms a ground beam 31 having an angle of depression θ from the car 4 to the road surface 5 and radiates radar waves. The angle of depression of a beam is an angle of a beam which tilts with respect to the road surface 5, based on the horizontal beam 30 parallel with the road surface 5 used as a reference, when the beam is directed toward the road surface 5. The angle of depression θ of the ground beam 31 is a value greater than 0. The ground beam 31 is an example of a first beam having a first angle of depression. The angle of depression θo of the horizontal beam 30 is 0°. The horizontal beam 30 is an example of a second beam having a second angle of depression, which is smaller than the first angle of depression.

A determination as to whether the obstacle 6 is moving or still is explained as follows. If the ground velocity of the car 4 is detected in environments different from those, such as the timing, measurement position, or module, in which the relative velocity of the obstacle 6 is detected, the calculated moving velocity of the obstacle 6 may not precisely reflect the actual velocity. Thereby, the precision in making a determination as to whether the obstacle 6 is a moving object or a still object is decreased. That is, if a radar transmitter and receiver for detecting the relative velocity of an obstacle and a radar transmitter and receiver for detecting the velocity of the car 4 are separately provided, the environments in which the relative velocity of an obstacle is detected may differ from those in which the velocity of the car 4 is detected, which may decrease the precision in making a determination as to whether the obstacle is a moving object or a still object. Accordingly, in the first embodiment, as shown in FIGS. 2 and 3, by using the single radar transmitter and receiver 2, the horizontal beam 30 and the ground beam 31 are selectively and alternately switched. Then, the relative velocity of the obstacle 6 is detected by using the horizontal beam 30, while the velocity of the car 4 running on the road surface 5, that is, the ground velocity of the car 4, is detected by using the ground beam 31. With this configuration, the ground velocity of the car 4 can be detected in the environments in which the relative velocity of the obstacle 6 is detected, thereby making it possible to make a determination as to whether the obstacle 6 is a moving object or a still object with high precision.

By using the object detection device configured as described above, moving objects and still objects are detected in the following manner in the first embodiment.

A description will first be given, with reference to FIGS. 2 and 3, of the operation for detecting velocities of objects, such as the relative velocity of the obstacle 6 and the ground velocity of the car 4. The Doppler frequency analyzer 11 of the control unit 10 performs FFT processing on the basis of the baseband signal Sr2 received from the radar control circuit 20 so as to extract a Doppler frequency Δf, which indicates a difference between the frequency fo of a transmitted radio signal and the frequency fo+Δf of a reflected wave signal. The Doppler frequency analyzer 11 then calculates the Doppler velocity Vd from the extracted Doppler frequency Δf, the frequency fo of radar waves, and the speed of light C according to the following equation (1).

Vd=C×Δf/(2fo) (1)

In the case of horizontal transmission in which a radio signal is transmitted by using the horizontal beam 30, the Doppler frequency analyzer 11 determines the Doppler velocity Vd calculated by equation (1) to be the relative velocity of the obstacle 6. Concerning the relative velocity of the obstacle 6, the direction in which the obstacle 6 is approaching the car 4 is a positive direction, while the direction in which the obstacle 6 is moving away from the car 4 is a negative direction. In the case of ground transmission in which a radio signal is transmitted by using the ground beam 31, the Doppler velocity Vd calculated by equation (1) is a velocity in the direction of the ground beam 31, and it is required to be converted into a velocity in the horizontal direction. Thus, the Doppler frequency analyzer 11 divides the Doppler velocity Vd by a conversion factor cos θ on the basis of the angle of depression θ of the ground beam 31 so as to calculate the vehicle ground velocity V according to the following equation (2).

V=Vd/cos θ (2)

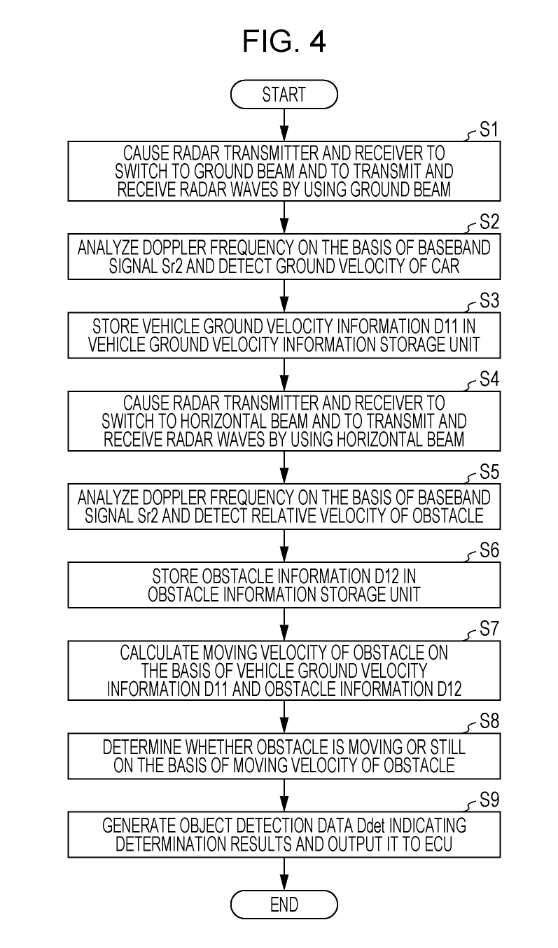

FIG. 4 is a flowchart illustrating object detection processing performed by the object detection device shown in FIG. 1. Object detection processing of the first embodiment will be discussed below with reference to FIG. 4. The object detection processing in FIG. 4 is performed by the control unit 10 of the object detection device.

In step S1, the control unit 10 first generates a radar control signal Sc1 and outputs it to the radar control circuit 20 so as to cause the radar transmitter and receiver 2 to switch the beam of the transmit antenna 22 to the ground beam 31 and to transmit and receive radar waves by using the ground beam 31. Then, in step S2, by using the Doppler frequency analyzer 11, the control unit 10 analyzes the Doppler frequency on the basis of the baseband signal Sr2 indicating the results of transmitting and receiving radar waves in step S1 so as to detect the vehicle ground velocity V of the car 4. In step S2, the control unit 10 performs FFT processing on the baseband signal Sr2 so as to extract the frequency difference between the reflected wave signal and the transmit signal Sra as the Doppler frequency, and then calculates the vehicle ground velocity by using equations (1) and (2). Then, in step S3, the control unit 10 stores the vehicle ground velocity information D11 in the vehicle ground velocity information storage unit 12, the vehicle ground velocity information D11 indicating the ground velocity of the car 4 detected in step S2.

Then, in step S4, the control unit 10 outputs the radar control signal Sc1 to the radar control circuit 20 so as to cause the radar transmitter and receiver 2 to switch the beam of the transmit antenna 22 to the horizontal beam 30 and to transmit and receive radar waves by using the horizontal beam 30. Then, in step S5, by using the Doppler frequency analyzer 11, the control unit 10 analyzes the Doppler frequency on the basis of the baseband signal Sr2 indicating the results of transmitting and receiving radar waves in step S4 and calculates the relative velocity of the obstacle 6 by using equation (1). In this case, on the basis of the baseband signal Sr2, the control unit 10 also extracts a delay time Δt of the reflected wave signal indicating a delay from the transmit signal Sra, and detects the relative distance of the obstacle 6 regarding the object detection device on the basis of the delay time Δt. The delay time Δt corresponds to the path length L=C×Δt indicating the distance that light travels between the object detection device and the obstacle 6. The control unit 10 calculates half of the path length L as the relative distance of the obstacle 6. In step S6, the control unit 10 stores the obstacle information D12 in the obstacle information storage unit 13, the obstacle information D12 indicating the relative velocity and the relative distance of the obstacle 6 and the reflection intensity detected in step S5.

Then, in step S7, the control unit 10 reads the vehicle ground velocity information D11 from the vehicle ground velocity information storage unit 12 and the obstacle information D12 from the obstacle information storage unit 13. The control unit 10 then performs comparison processing for comparing the vehicle ground velocity information D11 and the obstacle information D12 with each other, thereby calculating the moving velocity of the obstacle 6. In step S7, the moving velocity of the obstacle 6 is calculated by subtracting the relative velocity of the obstacle 6 indicated by the obstacle information D12 from the vehicle ground velocity indicated by the vehicle ground velocity information D11.

Then, in step S8, the control unit 10 determines whether the obstacle 6 is moving or still, on the basis of the moving velocity of the obstacle 6 detected in step S7. In step S8, the information comparison calculator 14 of the control unit 10 makes a determination as to whether or not the moving velocity of the obstacle 6 is equal to or greater than a predetermined threshold velocity, for example, 1 km per hour, thereby determining whether the obstacle 6 is moving or still. In step S9, on the basis of the determination result of step S8, the control unit 10 generates object detection data Ddet indicating the presence of the obstacle 6 and whether the obstacle 6 is moving or still and outputs the object detection data Ddet to the ECU 1. The control unit 10 then terminates the object detection processing. The ECU 1 controls the braking or issues a warning by using the display unit 40, on the basis of the object detection data Ddet. The above-described object detection processing is repeatedly performed at predetermined regular intervals, such as 0.1 seconds. This processing is performed in an object detection processing step. A calibration step of adjusting a change in the output of a radar system due to the temperature characteristics may be provided before or after the object detection processing step.

In the above-described object detection processing, the period for which ground transmission in step S1 is performed is set to be shorter than that for which horizontal transmission in step S4 is performed. A reflected wave signal in ground transmission quickly returns from the road surface 5 and has high reflection intensity. Accordingly, by setting the period of ground transmission to be shorter than that of horizontal transmission for detecting an obstacle, an obstacle can be detected efficiently.

In the above-described object detection processing, by selectively and alternately switching between the horizontal beam 30 and the ground beam 31 in the radar transmitter and receiver 2, the relative velocity of the obstacle 6 and the ground velocity of the car 4 are detected together by the radar transmitter and receiver 2. With this configuration, it is possible to make a determination as to whether the obstacle 6 is moving or still with high precision, and a pedestrian, for example, may also be identified.

The object detection device configured as described above is an object detection device to be mounted on the car 4 running on the road surface 5 so as to detect the obstacle 6 around the car 4. The object detection device includes the radar transmitter and receiver 2 and the Doppler frequency analyzer 11. The radar transmitter and receiver 2 includes the transmit antenna 22 and the receive antenna 24. The transmit antenna 22 is able to selectively switch between the ground beam 31 having a first angle of depression θ to be transmitted to the road surface 5 and the horizontal beam 30 having a second angle of depression θo, which is smaller than the first angle of depression θ, to be transmitted to the obstacle 6. The radar transmitter and receiver 2 transmits radio signals by alternately switching between the ground beam 31 and the horizontal beam 30 of the transmit antenna 22, and receives, by using the receive antenna 24, reflected wave signals indicating reflected waves returned in response to the transmitted radio signals. The Doppler frequency analyzer 11 detects the moving velocity of the car 4 on the basis of a radio signal transmitted by using the ground beam 31 and a reflected wave signal obtained as a result of the radio waves of the radio signal being reflected on the road surface 5. The Doppler frequency analyzer 11 also detects the relative velocity of the obstacle 6 regarding the car 4, on the basis of a radio signal transmitted by using the horizontal beam 30 and a reflected wave signal obtained as a result of the radio waves of the radio signal being reflected on the obstacle 6.

In the first embodiment, the ground velocity of the car 4 and the relative velocity of the obstacle 6 are detected together by using the single radar transmitter and receiver 2. Accordingly, the occurrence of error components (for example, an error due to tire slip) caused by the use of an external vehicle velocity sensor is suppressed. Additionally, since the relative velocity of the obstacle 6 and the ground velocity of the car 4 detected by the same radar transmitter and receiver 2 are compared with each other, errors are less likely to occur. It is thus possible to detect the movement of an object with higher precision than the related art.

In the object detection device of the first embodiment, in step S9, the control unit 10 outputs the object detection data Ddet indicating the determination results obtained in step S8 to the ECU 1. Then, the ECU 1 may determine, on the basis of the detection results obtained in step S8, whether or not the detected object will be likely to collide with the car 4. If the object will be likely to collide with the car 4, the ECU 1 may generate a warning signal and warn the car 4 by using the warning signal that the obstacle 6 is approaching.

In the object detection processing of the first embodiment, the control unit 10 may detect whether or not there is an object that has reflected radar waves. For example, on the basis of the baseband signal Sr2 obtained by horizontal transmission, the control unit 10 may determine whether or not the reflection intensity Pw of received reflected waves exceeds a predetermined threshold, thereby detecting whether or not there is an object that has reflected radar waves.

### Second Embodiment

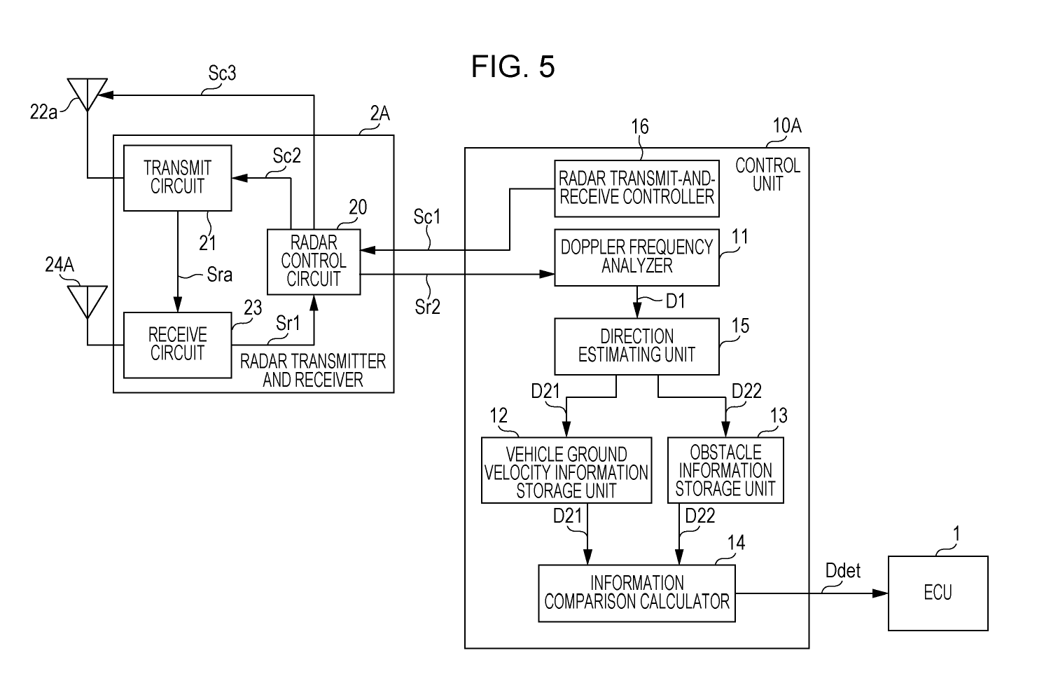

FIG. 5 is a block diagram illustrating an example of the configuration of an object detection device according to a second embodiment of the present disclosure. In the first embodiment, by selectively switching between a horizontal beam and a ground beam, the Doppler velocity of a reflected wave signal in ground transmission and that in horizontal transmission are analyzed. In the second embodiment, by estimating the direction from which a reflected wave signal arrives at a radar transmitter and receiver 2A (hereinafter referred to as the “direction of arrival”), the direction in which a detected object is positioned is detected. The object detection device of the second embodiment differs from that of the first embodiment shown in FIG. 1 in that, instead of the radar transmitter and receiver 2, a radar transmitter and receiver 2A is disposed, and instead of the control unit 10, a control unit 10A is disposed. The radar transmitter and receiver 2A includes a receive antenna 24A instead of the receive antenna 24 and a transmit antenna 22a instead of the transmit antenna 22. The control unit 10A also includes a direction estimating unit 15 in addition to the elements of the control unit 10 of the first embodiment. The configurations of the other elements of the object detection device according to the second embodiment are the same or similar to those of the first embodiment. The elements of the object detection device different from those of the first embodiment will be mainly discussed below.

The receive antenna 24A of the radar transmitter and receiver 2A is constituted by an array antenna including a plurality of receive antenna elements disposed at predetermined intervals. The receive antenna 24A receives, by using the receive antenna elements, a reflected wave signal indicating reflected waves returned in response to radar waves transmitted from the transmit antenna 22a. The plurality of receive antenna elements are disposed at, for example, different horizontal positions. Alternatively, the plurality of receive antenna elements may be disposed in the form of a two-dimensional array. The transmit antenna 22a selectively switches between a horizontal beam 33 and a ground beam 32. The receive circuit 23 generates a received signal Sr1 in response to the reflected wave signal, which is received as multiple signals by the respective receive antenna elements of the receive antenna 24A, and outputs the received signal Sr1 to the radar control circuit 20. The radar control circuit 20 performs predetermined signal processing on the received signal Sr1 so as to generate a baseband signal Sr2, and transmits the baseband signal Sr2 to the Doppler frequency analyzer 11 of the control unit 10A.

On the basis of the baseband signal Sr2, the Doppler frequency analyzer 11 extracts Doppler frequencies of the signals received by the respective receive antenna elements so as to calculate Doppler velocities. The Doppler frequency analyzer 11 then generates Doppler analysis information D1 including information concerning the Doppler velocities and the baseband signal Sr2, and outputs the Doppler analysis information D1 to the direction estimating unit 15.

On the basis of the Doppler analysis information D1, the direction estimating unit 15 calculates a correlation matrix or an evaluation function indicating a phase difference between multiple signals received by the respective receive antenna elements of the receive antenna 24A (for example, see Japanese Unexamined Patent Application Publication No. 2014-163753) so as to estimate the direction of arrival of the reflected waves returned from the road surface 5 or an obstacle. The direction estimating unit 15 separates a reflected wave component having a specific Doppler frequency from the multiple signals, on the basis of the Doppler analysis information D1, so as to estimate the direction of arrival of the reflected wave signal having this reflected wave component. In the case of ground transmission, the direction estimating unit 15 stores vehicle ground velocity information D21 in the vehicle ground velocity information storage unit 12, the vehicle ground velocity information D21 indicating a detected vehicle ground velocity corresponding to the estimated direction. In the case of horizontal transmission, the direction estimating unit 15 stores obstacle information D22 in the obstacle information storage unit 13, the obstacle information D22 indicating the relative velocity of a detected obstacle and the estimated direction in which the detected obstacle is positioned.

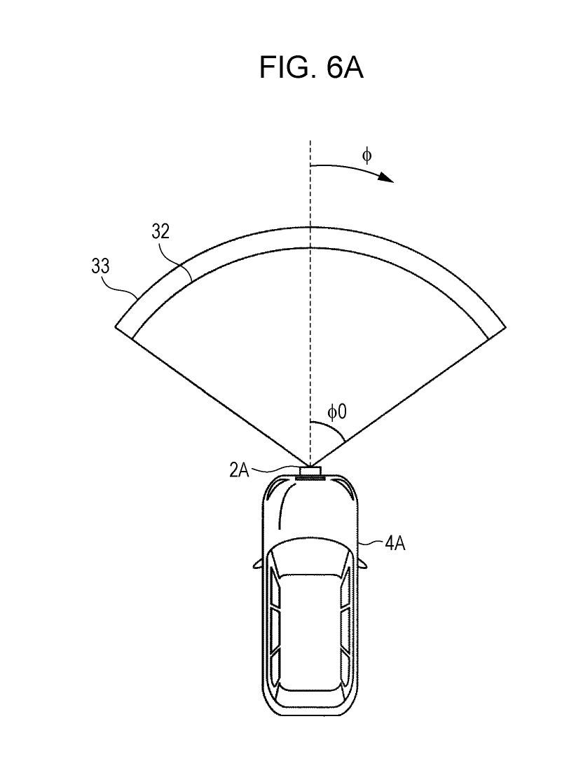

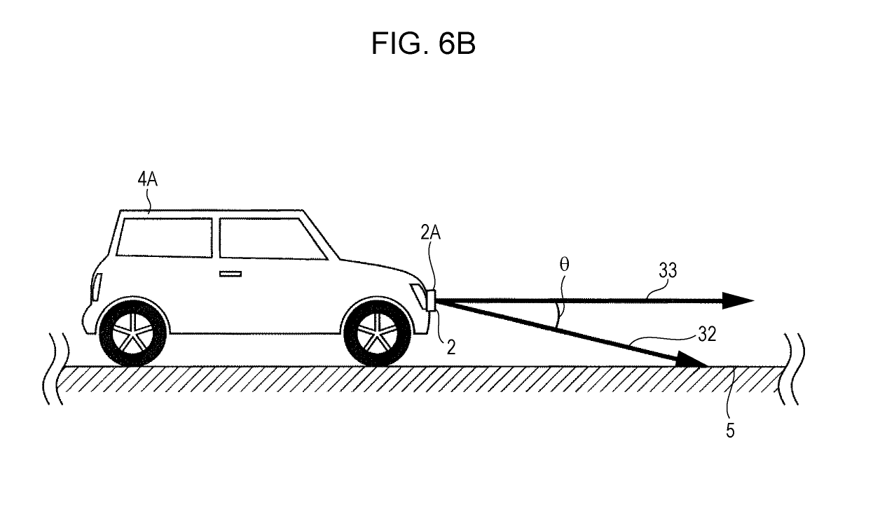

FIG. 6A is a plan view illustrating a car 4A on which the object detection device shown in FIG. 5 is mounted. FIG. 6B is a side view illustrating the car 4A shown in FIG. 6A. As shown in FIGS. 6A and 6B, the radar transmitter and receiver 2A of the object detection device forms a ground beam 32 and a horizontal beam 33 in a predetermined angle range of −φ0 to φ0 in an azimuth φ direction ahead of the car 4A. The horizontal beam 33 and the ground beam 32 have a wider angle than the horizontal beam 30 and the ground beam 31 of the first embodiment. Each of the horizontal beam 33 and the ground beam 32 has an azimuth width equal to or greater than a predetermined azimuth width. The azimuth width of the horizontal beam 33 may be different from that of the ground beam 32. The range of the azimuth width of the horizontal beam 33 and the ground beam 32 may each be, for example, 30° to 180°, 40° to 90°, or 50° to 60°. The azimuth φ is an angle from a reference direction, for example, the forward direction of the car 4, on a plane on which the transmit antenna 22a and the receive antenna 24A are installed, which is parallel with the road surface 5.

In the second embodiment, in FIGS. 6A and 6B, by analyzing the phase difference between signals obtained as a result of the plurality of receive antenna elements receiving a reflected wave signal, the azimuth φ of a reflected wave signal within the angle range of −φ0 to φ0 is estimated. In the case of horizontal transmission using the horizontal beam 33, the azimuth φ at which an object (e.g. the obstacle 6), which has reflected radar waves, is positioned is detected. In the case of ground transmission using the ground beam 32, the ground velocity of the car 4A at a specific azimuth φ is calculated by using equation (2) as a vehicle ground velocity.

On the basis of the angle of depression θ of the ground beam 32 and the estimated azimuth φ, the control unit 10A may detect the moving velocity Vm of the car 4A in the forward direction by dividing the Doppler velocity Vd of the reflected wave signal returned in response to the ground beam 32 by a conversion coefficient cos θ×cos φ according to the following equation (3).

Vm=Vd/(cos θ×cos φ) (3)

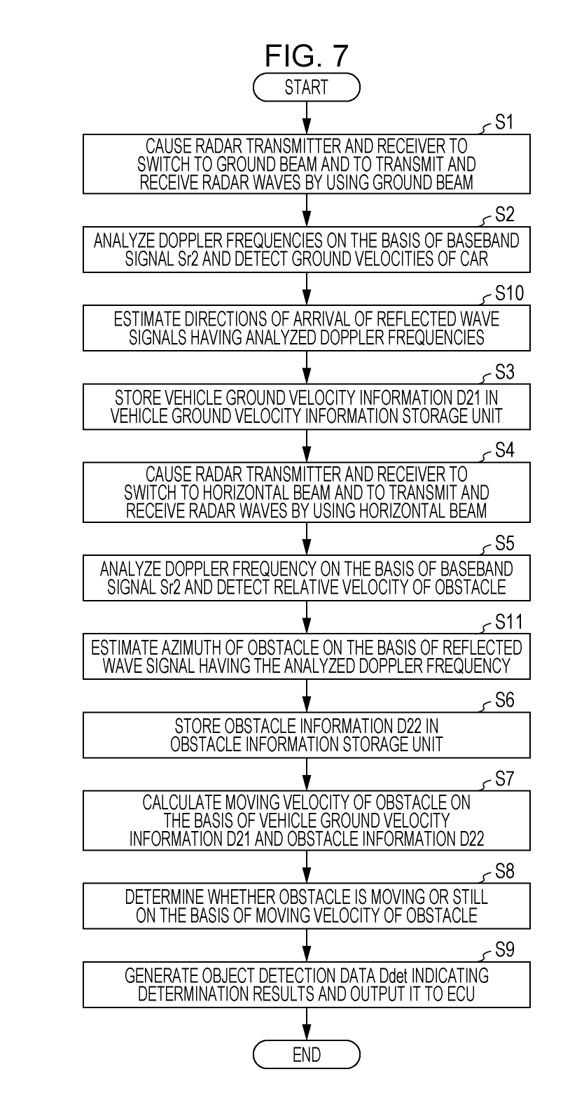

FIG. 7 is a flowchart illustrating object detection processing performed by the object detection device shown in FIG. 5. In addition to steps of the object detection processing shown in FIG. 4, the control unit 10A executes steps S10 and S11. Steps S10 and S11 will be mainly discussed below.

In step S1, the control unit 10A receives a reflected wave signal by using the plurality of receive antenna elements of the receive antenna 24A. Then, in step S2, the control unit 10A analyzes multiple Doppler frequencies corresponding to different directions, on the basis of the multiple signals received by the plurality of receive antenna elements, so as to calculate multiple Doppler velocities and ground velocities corresponding to the different directions by using equations (1) and (2). For example, the control unit 10A calculates a Doppler velocity and a ground velocity for each of the signals received by the plurality of receive antenna elements. Then, in step S10, by using the direction estimating unit 15, the control unit 10A estimates the directions of arrival of the reflected wave signal having the Doppler frequencies analyzed in step S2, on the basis of the phase difference between the multiple signals received by the receive antenna elements in step S1. Then, in step S3, the control unit 10A stores the vehicle ground velocity information D21 in the vehicle ground velocity information storage unit 12, the vehicle ground velocity information D21 indicating the ground velocities of the car 4A at the respective azimuths φ estimated in step S10.

Then, in step S4, the control unit 10A switches the beam of the transmit antenna 22a to the horizontal beam 33 and executes steps S4 and S5 by using the plurality of receive antenna elements. If, in step S4, the radar transmitter and receiver 2A has received multiple reflected wave signals from a plurality of obstacles, in step S5, the control unit 10A extracts Doppler frequencies of multiple reflected wave components on the basis of the reflected wave signals so as to detect relative velocities corresponding to the respective Doppler frequencies. In step S11, for each of Doppler frequencies corresponding to detected relative velocities, on the basis of the phase difference between the plurality of signals obtained by the plurality of receive antenna elements, the control unit 10A estimates the direction of arrival of this reflected wave signal by using the direction estimating unit 15, and then estimates the azimuth φ of an obstacle 6 having the detected relative velocity.

In step S6, the control unit 10A stores the obstacle information D22 in the obstacle information storage unit 13, the obstacle information D22 indicating the relative velocity and the relative distance of an obstacle 6 detected in step S5 and the azimuth φ estimated in step S11. Thereafter, the control unit 10A executes steps S7 through S9 in a manner similar to those of FIG. 4.

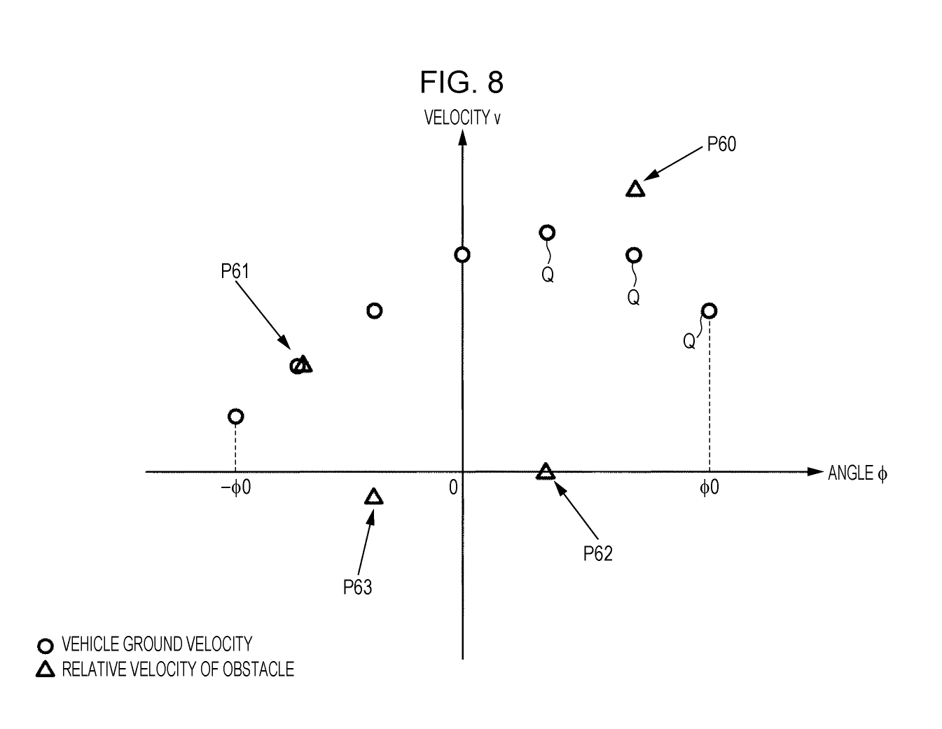

FIG. 8 is a graph illustrating the results of detecting the velocities of objects by the object detection processing shown in FIG. 7. FIG. 8 shows multiple vehicle ground velocities Q and relative velocities P60 through P63 of a plurality of obstacles detected in a range of the azimuth of −φ0 to φ0 in the forward direction of the car 4A (see FIG. 6A). The multiple ground velocities Q are ground velocities of the car 4A at the respective azimuths φ estimated in step S10 of FIG. 7. The multiple relative velocities P60 through P63 are relative velocities of a plurality of obstacles at which the respective azimuths φ estimated in step S11 of FIG. 7. Concerning the relative velocities of the obstacles, the direction in which an obstacle is approaching the car 4A is set to be a positive direction, and the direction in which an obstacle is moving away from the car 4A is set to be a negative direction.

In FIG. 8, the relative velocity P62 of the obstacle having a velocity v=0 indicates a moving object having the same moving velocity as the car 4A. The relative velocity P63 of the obstacle having a velocity v<0 indicates a moving object moving away from the car 4A. The relative velocities P60 and P61 of the obstacles having a velocity v>0 indicate obstacles relatively approaching the car 4A from the forward direction. An obstacle relatively approaching the car 4A may be a moving object or a still object. The control unit 10A then compares each of the relative velocities P60 and P61 of the respective obstacles with the ground velocity Q at the corresponding azimuth φ by using the information comparison calculator 14 so as to determine whether each of the obstacles is a moving object or a still object. The relative velocity P61 of one obstacle coincides with the ground velocity Q at the same azimuth φ as that of the relative velocity P61. Accordingly, the control unit 10A determines that this obstacle is a still object. In contrast, the relative velocity P60 of the other obstacle is greater than the ground velocity Q at the same azimuth φ as that of the relative velocity P60. Accordingly, the control unit 10A determines that this obstacle is a moving object approaching the car 4A.

As described above, by estimating the direction of arrival of reflected wave signals by using the receive antenna 24A, obstacles in a wide range of azimuths of −φ0 to φ0 can be detected, as shown in FIG. 8. The relative velocities of obstacles in the azimuths of −φ0 to φ0 are detected and are then compared with the ground velocities at the same azimuths φ as those of the relative velocities. Thus, a determination as to whether a detected obstacle is a moving object or a still object can be made in a wide range.

In the second embodiment, Doppler frequencies are calculated by using the Doppler frequency analyzer 11 in step S5. Accordingly, even if there are a plurality of obstacles positioned at the same distance from the object detection device, a reflected wave component returned from each object can be separated from multiple reflected wave signals. That is, since calculations of Doppler frequencies performed by the Doppler frequency analyzer 11 by using FFT are based on orthogonal transform, it is theoretically possible to completely separate signal components having different calculation results from each other. Then, in step S11 subsequent to step S5, the directions of arrival of reflected wave signals are estimated by using the direction estimating unit 15 on the basis of the Doppler analysis information D1. Accordingly, even if the levels of the reflected waves returned from a plurality of objects are nonuniform, it is possible to estimate the azimuth φ of each object.

### Third Embodiment

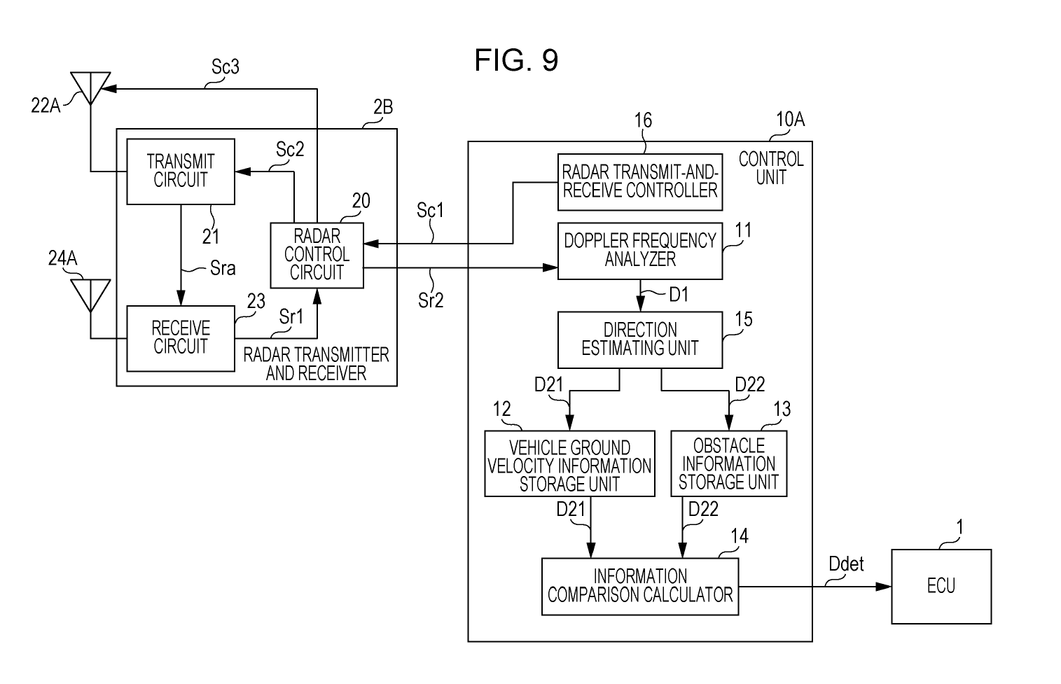

FIG. 9 is a block diagram illustrating an example of the configuration of an object detection device according to a third embodiment of the present disclosure. In the second embodiment, reflected wave signals returned from an obstacle and a road surface are received by the receive antenna 24A, and the directions of arrival of the reflected wave signals are estimated. In the third embodiment, while beams are being scanned in the azimuth φ directions, radio signals are transmitted to radiate radar waves. With this arrangement, the direction of arrival of a reflected wave signal is estimated with higher precision. The object detection device of the third embodiment shown in FIG. 9 differs from that of the second embodiment shown in FIG. 5 in that, instead of the radar transmitter and receiver 2A, a radar transmitter and receiver 2B is disposed. The radar transmitter and receiver 2B includes a transmit antenna 22A instead of the transmit antenna 22a. The configurations of the other elements of the object detection device according to the third embodiment are the same or similar to those of the second embodiment. The elements of the object detection device different from those of the second embodiment will be mainly discussed below.

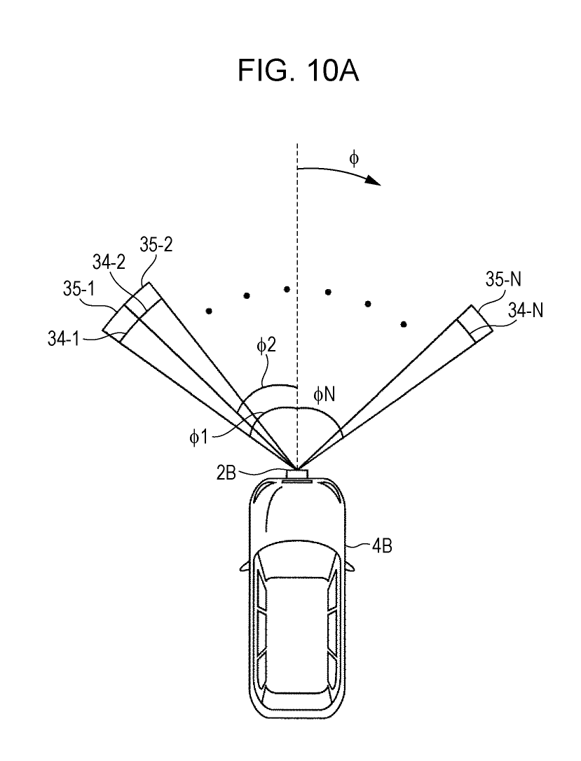

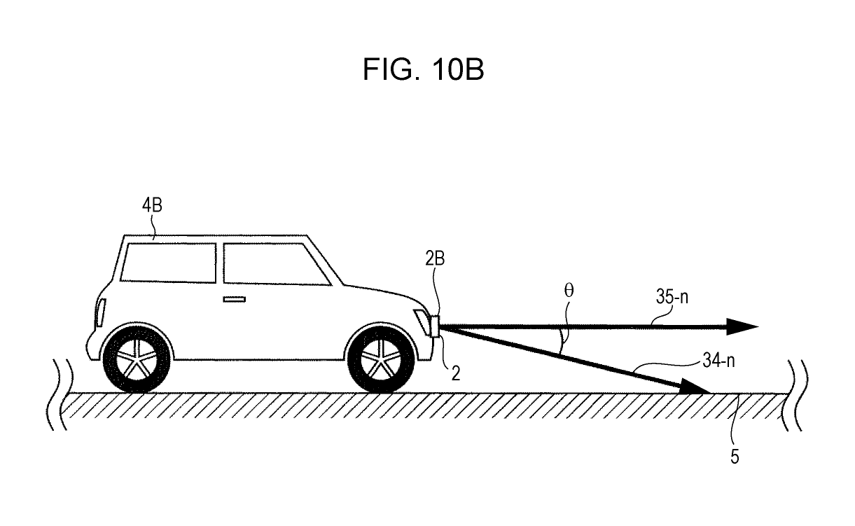

FIG. 10A is a plan view illustrating a car 4B on which the object detection device shown in FIG. 9 is mounted. FIG. 10B is a side view illustrating the car 4B shown in FIG. 10A. The transmit antenna 22A shown in FIG. 9 of the radar transmitter and receiver 2B shown in FIG. 10A forms ground beam 34-n and horizontal beam 35-n (n=1, 2, . . . , N) having a beamwidth smaller than the ground beam 32 and the horizontal beam 33 shown in FIG. 6A. The ground beams 34-1 to 34-N are an example of a first beam of the present disclosure, and the horizontal beams 35-1 to 35-N are an example of a second beam of the present disclosure. In the case of ground transmission, the radar transmitter and receiver 2B radiates radar waves by transmitting a radio signal while scanning the ground beams 34-1 through 34-N corresponding to azimuths φ1 through φN. In the case of horizontal transmission, the radar transmitter and receiver 2B radiates radar waves by transmitting a radio signal while scanning the horizontal beams 35-1 through 35-N corresponding to azimuths φ1 through φN. The azimuths of the scanning for ground transmission may be different from the azimuths of the scanning for horizontal transmission.

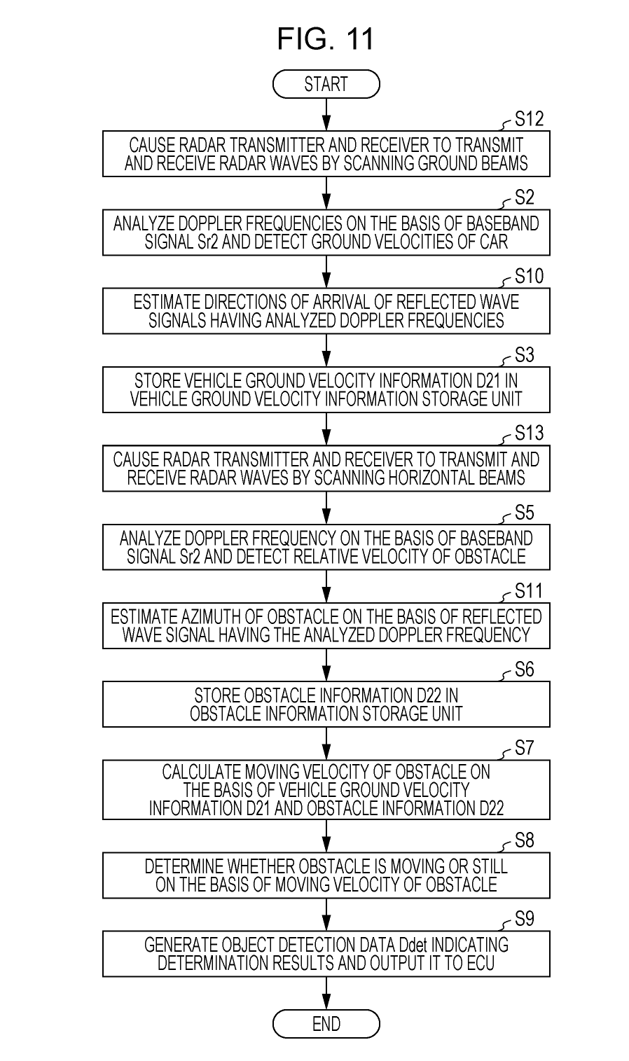

FIG. 11 is a flowchart illustrating object detection processing performed by the object detection device shown in FIG. 9. The object detection processing shown in FIG. 11 differs from that shown in FIG. 7 in that the control unit 10A executes steps S12 and S13 instead of steps S1 and S4, respectively. Steps S12 and S13 will be mainly discussed below.

In step S12, in ground transmission, the control unit 10A first causes the radar transmitter and receiver 2B to transmit and receive radar waves by sequentially scanning the ground beams 34-1 through 34-N. In step S12, the radar transmitter and receiver 2B receives, by using the plurality of receive antenna elements of the receive antenna 24A, a reflected wave signal indicating reflected waves returned in response to a radio signal transmitted by using the ground beam 34-n. In step S13, in a manner similar to ground transmission performed in step S12, in horizontal transmission, the control unit 10A causes the radar transmitter and receiver 2B to transmit and receive radar waves by sequentially scanning the horizontal beams 35-1 through 35-N.

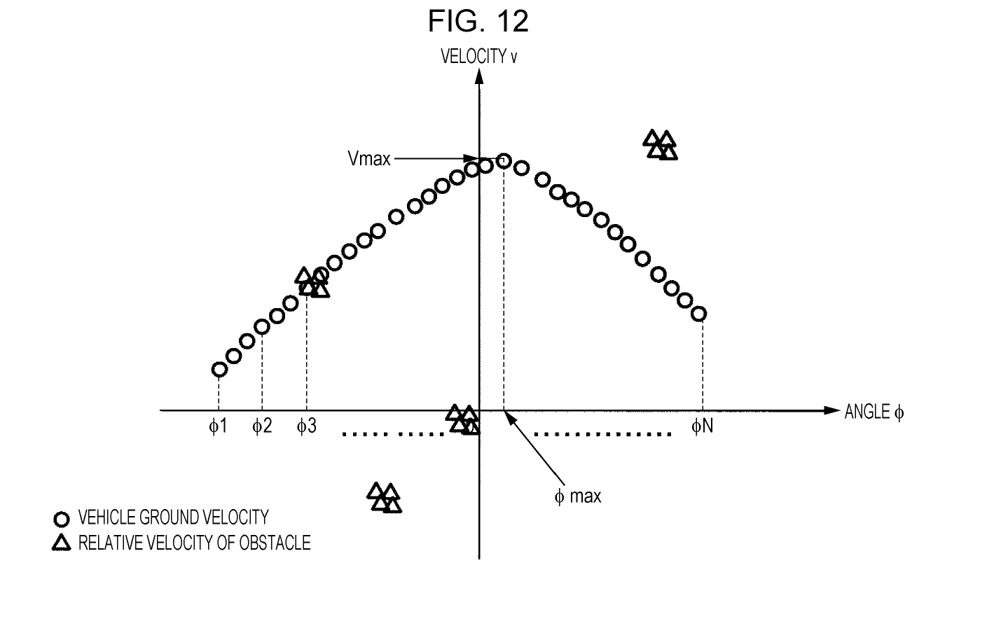

FIG. 12 is a graph illustrating the results of detecting the velocities of objects by the object detection processing shown in FIG. 11. The control unit 10A estimates the directions of arrival of the signals received as a result of scanning the ground beams 34-1 through 34-N at the azimuths φ1 through φN in step S10 of FIG. 11. FIG. 12 shows that, as a result of executing step S10, more vehicle ground velocities regarding the azimuth φ than those shown in FIG. 8 are detected with detection precision comparable to or higher than that of the detection results in FIG. 8. With regard to relative velocities of obstacles, the control unit 10A estimates the directions of arrival of signals received by using the horizontal beams 35-1 through 35-N in horizontal transmission in step S13 of FIG. 11. As a result, the precision in estimating the azimuths φ is enhanced, and the relative velocities of the obstacles at the multiple azimuths φ are detected. In this manner, in the third embodiment, the velocities of objects can be detected in greater detail than those in the detection results of FIG. 8.

Generally, if a plurality of objects having the same relative velocity and having the same relative distance from an object detection device are present in different azimuth φ directions, it is difficult to detect these objects by separating them from each other. In contrast, in the object detection device of the third embodiment, the transmission beam is divided into the horizontal beams 35-1 through 35-N so that a plurality of objects having the same relative velocity and having the same relative distance from the object detection device can be easily separated and detected at least in the units of transmission beams. In this manner, by detecting the velocities of objects in the individual azimuth φ directions with high precision, it is possible to enhance the precision in making a determination as to whether an obstacle is moving or still.

In detecting an object in the azimuth φ direction, by scanning beams having a narrower beamwidth, such as the ground beams 34-n and the horizontal beams 35-n, at the same level of power as that of a beam having a wider beamwidth in a predetermined angle range of −φ0 to φ0, a higher level of reflection intensity can be obtained. As a result, the signal-to-noise ratio (S/N ratio) is improved, thereby making it possible to detect objects with high precision.

The radar transmitter and receiver 2B of the third embodiment sequentially scans the ground beam 34-n in order of ground beams 34-1, 34-2, . . . , 34-N in ground transmission. However, the order of beams to be scanned is not restricted to this order, and the ground beam 34-n may be scanned in the reversed order. In horizontal transmission, as well as in ground transmission, the horizontal beam 35-n may be scanned by changing the order described above. In ground transmission, not all the ground beams 34-1 through 34-N have to be scanned. For example, some of the ground beams, such as ground beams 34-1, 34-3, 34-5, . . . , 34-N, may be scanned, and ground velocity at azimuth φ between adjacent two of the ground beams 34-1, 34-3, 34-5, . . . , and 34-N may be calculated by interpolation.

The angle of depression θ of the ground beam 34-n may be changed according to the antenna characteristics. In this case, if the angle of depression θ1 of the ground beam 34-1 in the azimuth φ1 direction is different from the angle of depression θ2 of the ground beam 34-2 in the azimuth φ2 direction, equations for calculating the ground velocities V1 and V2 in the azimuth φ1 and φ2 directions, respectively, are expressed by the following equations (4) and (5), instead of equation (2).

V1=Vd1/cos θ1 (4)

V2=Vd2/cos θ2 (5)

The Doppler velocities Vd1 and Vd2 in equations (4) and (5) are Doppler velocities corresponding to the Doppler frequencies extracted in ground transmission in the azimuth φ1 and φ2 directions.

### Fourth Embodiment

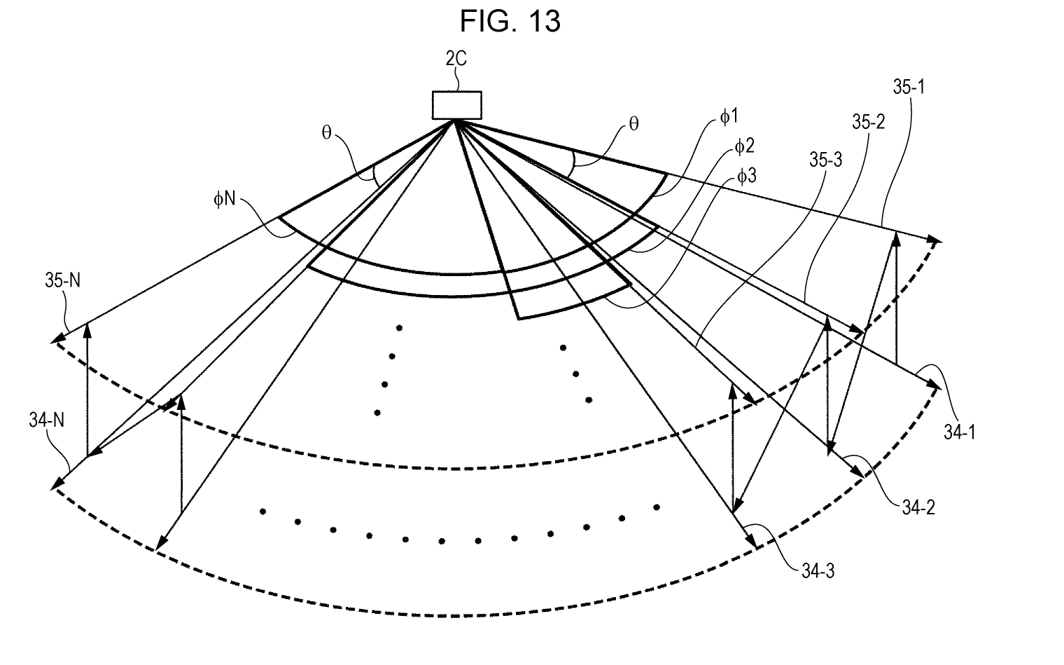

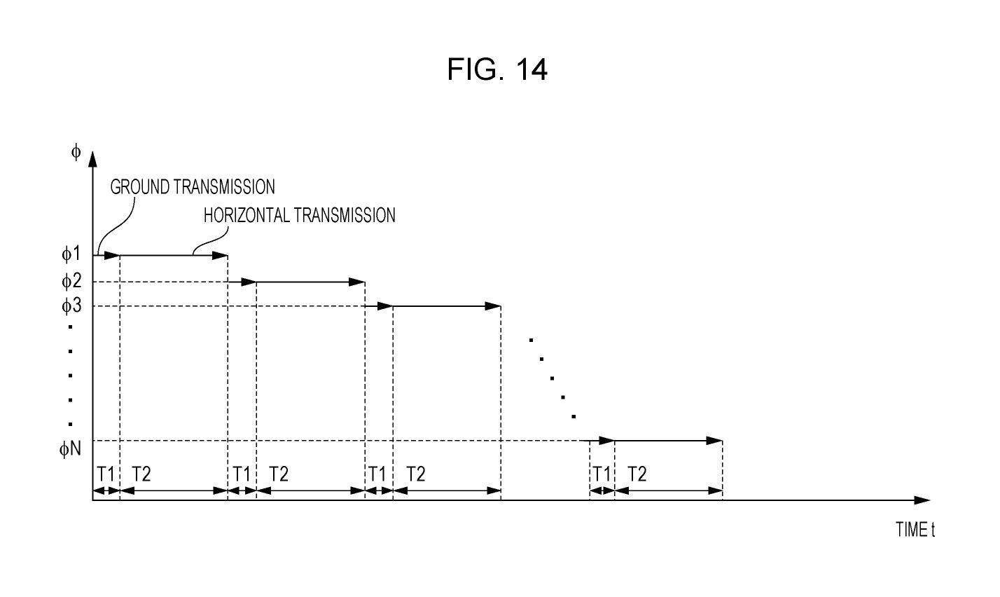

FIG. 13 is a perspective view illustrating a radar transmitter and receiver 2C of an object detection device according to a fourth embodiment of the present disclosure. FIG. 14 is a timing chart illustrating the timing of ground transmission and horizontal transmission in object detection processing performed by the object detection device including the radar transmitter and receiver shown in FIG. 13. In the third embodiment, after scanning of one of ground beams and horizontal beams at azimuths φ1 through φN has been completed, scanning of the other one of ground beams and horizontal beams is started. In the fourth embodiment, while performing scanning at each of the azimuths φ1 through φN, radio signals are transmitted by alternately switching between a ground beam and a horizontal beam. With this configuration, the timing at which a vehicle ground velocity is detected approximates to the timing at which a relative velocity of an object is detected, thereby making it possible to detect the moving velocity of an object with high precision.

As shown in FIG. 14, at the azimuth φ1, the radar transmitter and receiver 2C shown in FIG. 13 first performs ground transmission to transmit a radio signal by using a ground beam 34-1, and then, switches to a horizontal beam 35-1 and performs horizontal transmission to transmit a radio signal by using the horizontal beam 35-1. Then, at the azimuth φ2, the radar transmitter and receiver 2C performs ground transmission to transmit a radio signal by using a ground beam 34-2, and then, switches to a horizontal beam 35-2 and performs horizontal transmission to transmit a radio signal by using the horizontal beam 35-2. In this manner, at each azimuth φn, the radar transmitter and receiver 2C performs ground transmission by using the ground beam 34-n and horizontal transmission by using the horizontal beam 35-n while scanning the transmission beams in the azimuth φ direction.

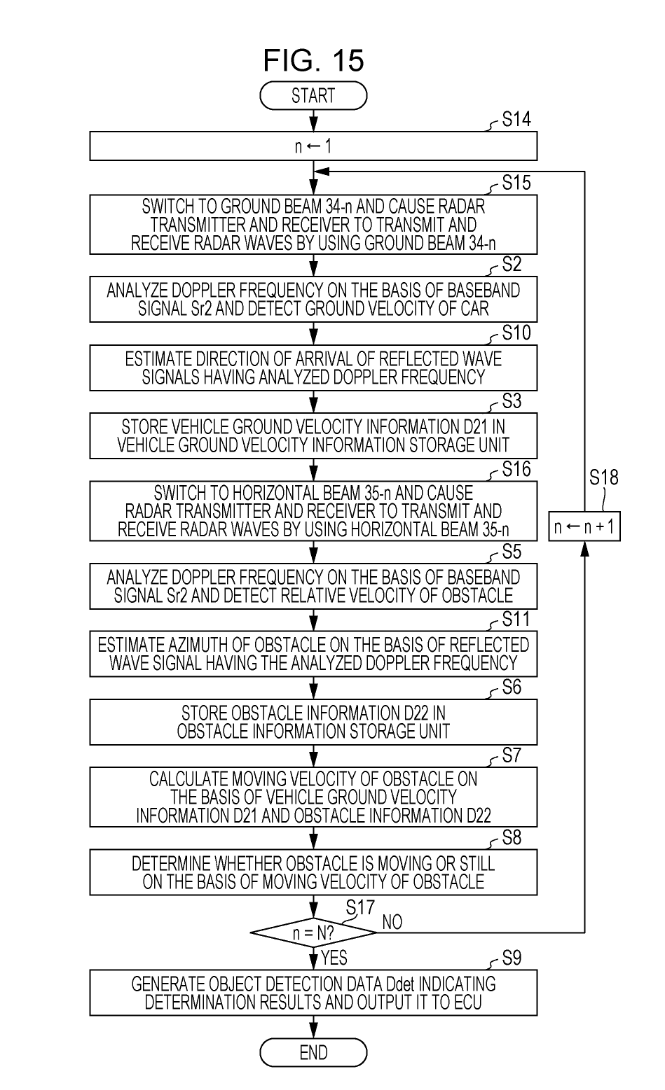

FIG. 15 is a flowchart illustrating object detection processing performed by the object detection device including the radar transmitter and receiver 2C shown in FIG. 13. The object detection processing shown in FIG. 15 differs from that shown in FIG. 11 in that the control unit 10A executes steps S14 through S17 instead of steps S12 and S13. Steps S14 through S17 will be mainly discussed below.

In step S14, the control unit 10A starts scanning a transmission beam starting from at the azimuth φ1. In processing concerning the azimuth φn, in step S15, the control unit 10A first switches a transmission beam to a ground beam 34-n and causes the radar transmitter and receiver 2C to transmit and receive radar waves by using the ground beam 34-n. On the basis of the results of executing step S15, steps S2 through S3 are executed in a manner similar to those of the object detection processing shown in FIG. 11. Then, in step S16, the control unit 10A switches a transmission beam to a horizontal beam 35-n and causes the radar transmitter and receiver 2C to transmit and receive radar waves by using the horizontal beam 35-n. On the basis of the results of executing step S16, steps S5 through S8 are executed in a manner similar to those of the object detection processing shown in FIG. 11.

Then, in step S17, the control unit 10A determines whether or not the azimuth φn=φN. If the result of step S17 is NO, the control unit 10A proceeds to step S18 and increments n by one. Then, in processing concerning the azimuth φ(n+1), the control unit repeats the above-described steps. If the result of step S17 is YES, the control unit 10A executes step S9 in a manner similar to that of the object detection processing shown in FIG. 11, and terminates this object detection processing.

By using the object detection device configured as described above, the timing at which a vehicle ground velocity is detected approximates to the timing at which a relative velocity of an object is detected, thereby making it possible to detect the moving velocity of an object with higher precision.

### Modified Examples

In the object detection devices according to the first through fourth embodiments, the radar transmitters and receivers 2, 2A, 2B, and 2C are mounted on the front sides of the cars 4, 4A, and 4B. However, the mounting position of the radar transmitters and receivers 2, 2A, 2B, and 2C is not restricted to this position. For example, the radar transmitters and receivers 2A, 2B, and 2C may be mounted on the right or left front side, the back side, or the right or left back side of the cars 4A and 4B (see FIGS. 6A and 10A).

The radar method used in the object detection device of each of the above-described embodiments may be the FM modulation method or the pulse-code modulation method, which is a digital method in which radar waves to be transmitted are represented in the form of pulses. If the pulse-code modulation method is employed, the transmit signal Sra split from a radio-transmit signal in the transmit circuit 21 is omitted, and instead, the radar control circuit 20 generates coded radar waves and outputs them to the transmit circuit 21. The radar control circuit 20 then performs correlation processing on a reflected wave signal Sr1 output from the receive circuit 23 and the generated coded radar waves so as to generate a signal Sr2 indicating the correlation processing results, and outputs the signal Sr2 to the Doppler frequency analyzer 11. The Doppler frequency analyzer 11 analyzes the signal Sr2 received from the radar control circuit 20 and detects the distance and the relative velocity of an obstacle.

The object detection device of each of the above-described embodiments includes the ECU 1. However, the provision of the ECU 1 may be omitted. For example, the control unit 10 may be directly connected to the display unit 40 and may have a function of issuing a warning or a function of controlling the braking. The control unit 10 may provide information based on the results of object detection processing to the ECU 1. For example, as shown in FIG. 12, the control unit 10 may extract the maximum ground velocity Vmax and its azimuth φmax from among ground velocities of the individual azimuths (I). Then, the control unit 10 may generate vehicle ground velocity information D21 indicating the extracted maximum ground velocity Vmax and azimuth φmax as the velocity and the traveling direction of the car 4 and output the vehicle ground velocity information D21 to the ECU 1. With this configuration, in the case of the occurrence of, for example, tire slip of the car 4, the ECU 1 is able to control the car 4 by using the velocity obtained by the radar system instead of using revolutions per minute (RPM) of the tires obtained by a vehicle velocity sensor.

In the object detection device of each of the above-described embodiments, the ground beams 31, 32, and 34-1 through 34-N may be formed as beams having a narrow beamwidth, such as pencil beams. In ground transmission, in addition to a reflected wave signal indicating reflected waves returned from the road surface, noise caused by reflected waves from surrounding objects or secondary reflected waves may occur. However, by narrowing the beamwidth of ground beams, the S/N ratio of a reflected wave signal indicating reflected waves returned from the road surface is improved. When a reflected wave signal is received in ground transmission, filtering processing may be performed by estimating the direction of arrival of the reflected waves within the direction of degree of depression, or filtering processing may be performed by setting a time window. This makes it possible to reduce noise in ground transmission.

In the object detection device of each of the above-described embodiments, in object detection processing, beams are selectively switched in order of a ground beam and a horizontal beam. Alternatively, object detection processing may be performed by selectively switching beams in order of a horizontal beam and a ground beam.

In the object detection device of each of the above-described embodiments, a horizontal beam having an angle of depression θo=0° is used as a second beam having a second angle of depression, which is smaller than the angle of depression θ of a ground beam. However, this is only an example, and the second angle of depression θo of the second beam may be in a range of 0°<θo<θ, or may be a negative angle of depression (θo<0°).

In the object detection device of each of the above-described embodiments, the radar transmitter and receiver is constituted by a millimeter-wave radar system. Alternatively, the radar transmitter and receiver may be constituted by a radar system radiating radar waves having electromagnetic waves in a frequency band other than the millimeter-wave band. The radar transmitter and receiver may be constituted by a laser radar system or an ultrasonic radar system.

In the object detection device of each of the above-described embodiments, the object detection device is mounted on the car 4, 4A, or 4B. However, the present disclosure is not restricted to this configuration, and a vehicle may include the object detection device of one of the above-described embodiments. Examples of vehicles including the object detection device are cars, bicycles, motorized bicycles, and motorcycles.

In the third and fourth embodiments, the receive antenna 24A including a plurality of receive antenna elements is used, and the ground velocity of the car 4B and the azimuth of an obstacle are estimated on the basis of the phase difference between multiple signals received by the plurality of receive antenna elements. However, the ground velocity of the car 4B and the azimuth of an obstacle may be estimated on the basis of the azimuths of scanning beams, instead of the phase difference between multiple signals received by the plurality of receive antenna elements.

### CONCLUSION OF EMBODIMENTS

An object detection device according to a first aspect of the present disclosure is an object detection device to be mounted on a mobile body which moves on a road surface so as to detect an object around the mobile body. The object detection device includes: a transmit antenna that is capable of selectively switching between a first beam having a first angle of depression and being transmitted to the road surface and a second beam having a second angle of depression and being transmitted to the object, the second angle of depression being smaller than the first angle of depression; a receive antenna; radio signal transmit-and-receive circuitry that alternately switches between the first and the second beams of the transmit antenna and transmits a radio signal and that receives, by using the receive antenna, a reflected wave signal returned in response to the transmitted radio signal; and velocity detection circuitry that detects a moving velocity of the mobile body, on the basis of a radio signal transmitted by using the first beam and a reflected wave signal obtained as a result of radio waves of the radio signal transmitted by using the first beam being reflected on the road surface, and that detects a relative velocity of the object regarding the mobile body, on the basis of a radio signal transmitted by using the second beam and a reflected wave signal obtained as a result of radio waves of the radio signal transmitted by using the second beam being reflected on the object.

With this configuration, the moving velocity of the mobile body is detected by using the first beam, while the relative velocity of the object is detected by using the second beam, thereby making it possible to detect the movement of the object with higher precision than the related art.

According to a second aspect of the present disclosure, the object detection device according to the first aspect further includes calculation circuitry that calculates a moving velocity of the object, on the basis of the moving velocity of the mobile body and the relative velocity of the object detected by the velocity detection circuitry.

With this configuration, the moving velocity of the object is calculated from the moving velocity of the mobile body and the relative velocity of the object detected by the velocity detection circuitry, thereby making it possible to obtain the moving velocity of the object with high precision.

According to a third aspect of the present disclosure, in the object detection device according to the second aspect, the calculation circuitry makes a determination as to whether the object is moving or still, on the basis of the calculated moving velocity of the object.

With this configuration, on the basis of the moving velocity of the object calculated from the moving velocity of the mobile body and the relative velocity of the object detected by the velocity detection circuitry, it is possible to determine whether the object is moving or still with high precision.

According to a fourth aspect of the present disclosure, in the object detection device according to one of the first through third aspects, the receive antenna includes a plurality of receive antenna elements that receive reflected wave signals. The object detection device further includes direction estimating circuitry that estimates a direction in which the object is positioned regarding the mobile body, on the basis of a phase difference between the reflected wave signals received by the plurality of receive antenna elements.

With this configuration, the direction in which the object is positioned regarding the mobile body is estimated by the direction estimating circuitry, thereby making it possible to detect the movement of the object together with the direction thereof.

According to a fifth aspect of the present disclosure, in the object detection device according to the fourth aspect, the radio signal transmit-and-receive circuitry scans the first beam in an azimuth direction so as to transmit a radio signal, and the direction estimating circuitry estimates the direction in which the object is positioned regarding the mobile body, on the basis of reflected wave signals returned in response to the radio signal transmitted by using the first beam.

With this configuration, it is possible to estimate the direction in which the object is positioned regarding the mobile body with higher precision, on the basis of the reflected wave signals returned in response to the radio signal transmitted by scanning the first beam.

According to a sixth aspect of the present disclosure, in the object detection device according to the fourth or fifth aspect, the radio signal transmit-and-receive circuitry scans the second beam in azimuth directions so as to transmit a radio signal. The velocity detection circuitry detects a plurality of ground velocities, on the basis of reflected wave signals returned in response to the radio signal transmitted by using the second beam. The direction estimating circuitry estimates a direction of each of the ground velocities in the azimuth directions.

With this configuration, a plurality of ground velocities are detected together with the directions thereof, thereby making it possible to obtain the moving velocity of the mobile body in each azimuth direction.

According to a seventh aspect of the present disclosure, in the object detection device according to the sixth aspect, the radio signal transmit-and-receive circuitry performs scanning in an azimuth direction by alternately switching between the first and second beams so as to sequentially transmit radio signals.

With this configuration, the timing at which a vehicle ground velocity is detected approximates to the timing at which a relative velocity of an object is detected, thereby making it possible to detect the movement of an object with higher precision.

According to an eighth aspect of the present disclosure, in the object detection device according to the sixth or seventh aspect, vehicle ground velocity information indicating a maximum ground velocity among the plurality of ground velocities and a direction of the maximum ground velocity estimated by the direction estimating circuitry is generated and output.

With this configuration, movement information indicating the maximum vehicle velocity and the direction thereof is output from the object detection device thereby making it possible to obtain the movement information from the object detection device.

A vehicle according to a ninth aspect of the present disclosure includes the object detection device according to one of the first through eighth aspects.

With this configuration, the relative velocity of an object regarding the vehicle and the velocity of the vehicle can be detected, thereby making it possible to detect the movement of the object with high precision by the vehicle.

An object detection device according to a tenth aspect of the present disclosure is an object detection device to be mounted on a mobile body which moves on a road surface so as to detect an object around the mobile body. The object detection device includes: a transmit antenna that selectively switches between a first beam having a first angle of depression and being directed to the road surface and a second beam having a second angle of depression and being directed to the object, the second angle of depression being smaller than the first angle of depression; a receive antenna; first circuitry that causes the transmit antenna to alternately switch between the first and the second beams and transmits radio signals by using the first beam and the second beam, and that receives, by using the receive antenna, reflected wave signals returned in response to the transmitted radio signals; and second circuitry that detects at least one ground velocity of the mobile body corresponding to at least one azimuth, on the basis of a radio signal transmitted by using the first beam and a reflected wave signal obtained as a result of radio waves of the radio signal transmitted by using the first beam being reflected on the road surface, and that detects a relative velocity of the object regarding the mobile body, on the basis of a radio signal transmitted by using the second beam and a reflected wave signal obtained as a result of radio waves of the radio signal transmitted by using the second beam being reflected on the object.

According to an eleventh aspect of the present disclosure, in the object detection device according to the tenth aspect, the first beam has a first azimuth width equal to or greater than a predetermined azimuth width. The second beam has a second azimuth width equal to or greater than the predetermined azimuth width. The at least one ground velocity includes a plurality of ground velocities corresponding to a plurality of azimuths. The receive antenna includes a plurality of receive antenna elements. The first circuitry receives the reflected wave signals by using the plurality of receive antenna elements. The second circuitry detects the plurality of ground velocities of the mobile body, on the basis of the radio signal transmitted by using the first beam, the reflected wave signal obtained as a result of radio waves of the radio signal transmitted by using the first beam being reflected on the road surface, and a phase difference between a plurality of signals obtained as a result of the plurality of receive antenna elements receiving the reflected wave signal. The second circuitry detects the relative velocity of the object regarding the mobile body and also estimates a direction in which the object is positioned regarding the mobile body, on the basis of the radio signal transmitted by using the second beam, the reflected wave signal obtained as a result of radio waves of the radio signal transmitted by using the second beam being reflected on the object, and a phase difference between a plurality of signals obtained as a result of the plurality of receive antenna elements receiving the reflected wave signal.

According to a twelfth aspect of the present disclosure, in the object detection device according to the tenth or eleventh aspect, the at least one ground velocity includes a plurality of ground velocities corresponding to a plurality of azimuths. The transmit antenna scans the first beam azimuthally. The first circuitry causes the transmit antenna to scan the first beam azimuthally to transmit the radio signal by using the first beam. The second circuitry detects the plurality of ground velocities of the mobile body, on the basis of the radio signal transmitted by using the first beam and the reflected wave signal obtained as a result of radio waves of the radio signal transmitted by using the first beam being reflected on the road surface.

According to a thirteenth aspect of the present disclosure, in the object detection device according to the twelfth aspect, the transmit antenna scans the second beam azimuthally. The first circuitry causes the transmit antenna to scan the second beam azimuthally to transmit the radio signal by using the second beam. The second circuitry detects the relative velocity of the object regarding the mobile body and also estimates a direction in which the object is positioned regarding the mobile body, on the basis of the radio signal transmitted by using the second beam and the reflected wave signal obtained as a result of radio waves of the radio signal transmitted by using the second beam being reflected on the object.

According to a fourteenth aspect of the present disclosure, in the object detection device according to the thirteenth aspect, after the first circuitry causes the transmit antenna to switch between the first and second beams to transmit the radio signals at one azimuth, the first circuitry changes the direction of the first and second beams to a subsequent azimuth and causes the transmit antenna to switch between the first and second beams to transmit the radio signals at the subsequent azimuth.

According to a fifteenth aspect of the present disclosure, in the object detection device according to one of the twelfth to fourteenth aspects, the second circuitry calculates a moving velocity of the object, on the basis of the plurality of ground velocities of the mobile body and the relative velocity of the object, and the direction in which the object is positioned.

According to a sixteenth aspect of the present disclosure, in the object detection device according to the fifteenth aspect, the second circuitry makes a determination as to whether the object is moving or still, on the basis of the calculated moving velocity of the object.

According to a seventeenth aspect of the present disclosure, in the object detection device according to one of the twelfth to sixteenth aspects, the second circuitry generates mobile body velocity information indicating a maximum ground velocity among the plurality of ground velocities and a direction of the maximum ground velocity, and outputs the mobile body velocity information.

A vehicle according to an eighteenth aspect of the present disclosure includes the object detection device according to one of the tenth through seventeenth aspects.

A velocity detection device according to a nineteenth aspect of the present disclosure is a velocity detection device to be mounted on a mobile body which moves on a road surface. The velocity detection device includes: a transmit antenna that azimuthally scans a beam having an angle of depression and being directed to the road surface; a receive antenna including one or more receive antenna elements; first circuitry that cause the transmit antenna to azimuthally scan the beam to transmit a radio signal by using the beam and that receives, by using the receive antenna, a reflected wave signal obtained as a result of radio waves of the transmitted radio signal being reflected on the road surface; and second circuitry that detects a plurality of ground velocities of the mobile body corresponding to a plurality of azimuths, on the basis of the radio signal and the reflected wave signal.

A vehicle according to a twentieth aspect of the present disclosure is a vehicle which moves on a road surface. The vehicle includes: a transmit antenna that azimuthally scans a beam having an angle of depression and being directed to the road surface; a receive antenna including one or more receive antenna elements; first circuitry that cause the transmit antenna to azimuthally scan the beam to transmit a radio signal by using the beam and that receives, by using the receive antenna, a reflected wave signal obtained as a result of radio waves of the transmitted radio signal being reflected on the road surface; second circuitry that detects a plurality of ground velocities of the vehicle corresponding to a plurality of azimuths, on the basis of the radio signal and the reflected wave signal; a brake that reduces a moving velocity of the vehicle; and an electronic control unit that adjusts the moving velocity of the vehicle by using the brake, on the basis of detection results obtained by the second circuitry.

According to a twenty first aspect of the present disclosure, in the scan of the first beam in the object detection device according to one of the twelfth to seventeenth aspects, the first beam has the first angle of depression in a first azimuth, and the first beam further has a third angle of depression in a second azimuth that is different from the first azimuth, the third angle of depression being different from the first angle of depression.

In the present disclosure, all or a part of any of unit, controller, analyzer, calculator, or any of functional blocks in the block diagrams shown in FIGS. 1, 5 and 9 may be implemented as one or more of electronic circuits including, but not limited to, a semiconductor device, a semiconductor integrated circuit (IC) or an LSI. The LSI or IC can be integrated into one chip, or also can be a combination of plural chips. For example, functional blocks other than a memory may be integrated into one chip. The name used here is LSI or IC, but it may also be called system LSI, VLSI (very large scale integration), or ULSI (ultra large scale integration) depending on the degree of integration. A Field Programmable Gate Array (FPGA) that can be programmed after manufacturing an LSI or a reconfigurable logic device that allows reconfiguration of the connection or setup of circuit cells inside the LSI can be used for the same purpose.

Further, it is also possible that all or a part of the functions or operations of the unit, controller, analyzer, calculator are implemented by executing software. In such a case, the software is recorded on one or more non-transitory recording media such as a ROM, an optical disk or a hard disk drive, and when the software is executed by a processor, the software causes the processor together with peripheral devices to execute the functions specified in the software. A system or apparatus may include such one or more non-transitory recording media on which the software is recorded and a processor together with necessary hardware devices such as an interface.

What is claimed is:

1. An object detection device to be mounted on a mobile body which moves on a road surface so as to detect an object around the mobile body, comprising:
a transmit antenna that selectively switches between a first beam having a first angle of depression and being directed to the road surface and a second beam having a second angle of depression and being directed to the object, the second angle of depression being smaller than the first angle of depression;
a receive antenna;
first circuitry that causes the transmit antenna to alternately switch between the first and the second beams and transmits radio signals by using the first beam and the second beam, and that receives, by using the receive antenna, reflected wave signals returned in response to the transmitted radio signals; and
second circuitry that detects at least one ground velocity of the mobile body corresponding to at least one azimuth, on the basis of a radio signal transmitted by using the first beam and a reflected wave signal obtained as a result of radio waves of the radio signal transmitted by using the first beam being reflected on the road surface, and that detects a relative velocity of the object regarding the mobile body, on the basis of a radio signal transmitted by using the second beam and a reflected wave signal obtained as a result of radio waves of the radio signal transmitted by using the second beam being reflected on the object.

2. The object detection device according to claim 1, wherein:
the first beam has a first azimuth width equal to or greater than a predetermined azimuth width;
the second beam has a second azimuth width equal to or greater than the predetermined azimuth width;
the at least one ground velocity includes a plurality of ground velocities corresponding to a plurality of azimuths;
the receive antenna includes a plurality of receive antenna elements;
the first circuitry receives the reflected wave signals by using the plurality of receive antenna elements; and
the second circuitry detects the plurality of ground velocities of the mobile body, on the basis of the radio signal transmitted by using the first beam, the reflected wave signal obtained as a result of radio waves of the radio signal transmitted by using the first beam being reflected on the road surface, and a phase difference between a plurality of signals obtained as a result of the plurality of receive antenna elements receiving the reflected wave signal, and the second circuitry detects the relative velocity of the object regarding the mobile body and also estimates a direction in which the object is positioned regarding the mobile body, on the basis of the radio signal transmitted by using the second beam, the reflected wave signal obtained as a result of radio waves of the radio signal transmitted by using the second beam being reflected on the object, and a phase difference between a plurality of signals obtained as a result of the plurality of receive antenna elements receiving the reflected wave signal.

3. The object detection device according to claim 1, wherein:
the at least one ground velocity includes a plurality of ground velocities corresponding to a plurality of azimuths;
the transmit antenna scans the first beam azimuthally;
the first circuitry causes the transmit antenna to scan the first beam azimuthally to transmit the radio signal by using the first beam; and
the second circuitry detects the plurality of ground velocities of the mobile body, on the basis of the radio signal transmitted by using the first beam and the reflected wave signal obtained as a result of radio waves of the radio signal transmitted by using the first beam being reflected on the road surface.

4. The object detection device according to claim 3, wherein:
the transmit antenna scans the second beam azimuthally;
the first circuitry causes the transmit antenna to scan the second beam azimuthally to transmit the radio signal by using the second beam; and
the second circuitry detects the relative velocity of the object regarding the mobile body and also estimates a direction in which the object is positioned regarding the mobile body, on the basis of the radio signal transmitted by using the second beam and the reflected wave signal obtained as a result of radio waves of the radio signal transmitted by using the second beam being reflected on the object.

5. The object detection device according to claim 4, wherein after the first circuitry causes the transmit antenna to switch between the first and second beams to transmit the radio signals at one azimuth, the first circuitry changes the direction of the first and second beams to a subsequent azimuth and causes the transmit antenna to switch between the first and second beams to transmit the radio signals at the subsequent azimuth.

6. The object detection device according to claim 4, wherein the second circuitry calculates a moving velocity of the object, on the basis of the plurality of ground velocities of the mobile body and the relative velocity of the object, and the direction in which the object is positioned.

7. The object detection device according to claim 6, wherein the second circuitry makes a determination as to whether the object is moving or still, on the basis of the calculated moving velocity of the object.

8. The object detection device according to claim 4, wherein the second circuitry generates mobile body velocity information indicating a maximum ground velocity among the plurality of ground velocities and a direction of the maximum ground velocity, and outputs the mobile body velocity information.

9. A vehicle comprising the object detection device according to claim 4.

10. A velocity detection device to be mounted on a mobile body which moves on a road surface, comprising:
a transmit antenna that azimuthally scans a beam having an angle of depression and being directed to the road surface;
a receive antenna including one or more receive antenna elements;
first circuitry that causes the transmit antenna to azimuthally scan the beam to transmit a radio signal by using the beam and that receives, by using the receive antenna, a reflected wave signal obtained as a result of radio waves of the transmitted radio signal being reflected on the road surface; and
second circuitry that detects a plurality of ground velocities of the mobile body corresponding to a plurality of azimuths, on the basis of the radio signal and the reflected wave signal.

11. A vehicle which moves on a road surface, comprising:
a transmit antenna that azimuthally scans a beam having an angle of depression and being directed to the road surface;
a receive antenna including one or more receive antenna elements;
first circuitry that causes the transmit antenna to azimuthally scan the beam to transmit a radio signal by using the beam and that receives, by using the receive antenna, a reflected wave signal obtained as a result of radio waves of the transmitted radio signal being reflected on the road surface;
second circuitry that detects a plurality of ground velocities of the vehicle corresponding to a plurality of azimuths, on the basis of the radio signal and the reflected wave signal;
a brake that reduces a moving velocity of the vehicle; and
an electronic control unit that adjusts the moving velocity of the vehicle by using the brake, on the basis of detection results obtained by the second circuitry.

12. The object detection device according to claim 3, wherein: in the scan of the first beam, the first beam has the first angle of depression in a first azimuth, and the first beam further has a third angle of depression in a second azimuth that is different from the first azimuth, the third angle of depression being different from the first angle of depression.
